(19) United States
(12) Patent Application Publication
(10) Pub. No.: US 2022/0253426 A1
(43) Pub. Date: Aug. 11, 2022

(54) EXPLAINING OUTLIERS IN TIME SERIES AND EVALUATING ANOMALY DETECTION METHODS

(71) Applicants: International Business Machines Corporation, Armonk, NY (US); The Board of Trustees of the University of Illinois, Urbana, IL (US)

(72) Inventors: Yada Zhu, Irvington, NY (US); Jinjun Xiong, Goldens Bridge, NY (US); Jingrui He, Champaign, IL (US); Lecheng Zheng, Savoy, IL (US); Xiaodong Cui, Chappaqua, NY (US)

(21) Appl. No.: 17/170,164

(22) Filed: Feb. 8, 2021

(51) Int. Cl. G06F 16/23; G06N 3/04; G06N 3/08

(52) U.S. Cl. CPC G06F 16/2365; G06N 3/08; G06N 3/04

(57) ABSTRACT

Time series data can be received. A machine learning model can be trained using the time series data. A contaminating process can be estimated based on the time series data, the contaminating process including outliers associated with the time series data. A parameter associated with the contaminating process can be determined. Based on the trained machine learning model and the parameter associated with the contaminating process, a single-valued metric can be determined, which represents an impact of the contaminating process on the machine learning model's future prediction. A plurality of different outlier detecting machine learning models can be used to estimate the contaminating process and the single-valued metric can be determined for each of the plurality of different outlier detecting machine learning models. The plurality of different outlier detecting machine learning models can be ranked according to the associated single-valued metric.

### STATEMENT REGARDING FEDERALLY SPONSORED RESEARCH OR DEVELOPMENT

This invention was made with Government support under IIS-1947203 and IIS-2002540 awarded by the National Science Foundation. The Government has certain rights to this invention.

### BACKGROUND

The present application relates generally to computers and computer applications, and more particularly to machine learning, evaluating machine learning anomaly detection and/or prediction models, and explaining impact of outliers on time series machine learning predictive models.

Outlier analysis is useful, for example, for data cleaning, anomaly detection, gaining insights into the hidden patterns. Outliers can impact the performance of artificial intelligence (AI) models in production, induce biased decision and may lead to a loss resulting from possibly inaccurate prediction. Despite the existing explanation techniques for black-box machine learning models using static data, interpretation of the impact of outliers in time series data and anomaly detection methods for streaming data or time series data remain to be solved.

### BRIEF SUMMARY

The summary of the disclosure is given to aid understanding of a computer system and methods described herewith, e.g., explaining outliers in time series data and evaluating anomaly detection methods such as machine learning and associated models, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system, the architectural structure, processor, register files, and/or their method of operation to achieve different effects.

A computer-implemented method, in one aspect, can include receiving time series data. The method can also include training a machine learning model using the time series data. The method can further include estimating a contaminating process based on the time series data, the contaminating process including outliers associated with the time series data. The method can also include determining a parameter associated with the contaminating process. The method can also include, based on the trained machine learning model and the parameter associated with the contaminating process, determining a single-valued metric representing an impact of the contaminating process on the machine learning model's future prediction.

In another aspect, the method can also include a plurality of different outlier detecting machine learning models estimating the contaminating process. The single-valued metric can be determined for each of the plurality of different outlier detecting machine learning models, where the plurality of different outlier detecting machine learning models is ranked according to the associated single-valued metric.

In another aspect, the method can also include generating the contamination process using a plurality of different machine learning structures, where a plurality of single-valued metrics is generated associated with the plurality of different machine learning structures respectively, where a machine learning structure is selected from the plurality of different machine learning structures based on the associated single-valued metric, and model parameters for the selected machine learning structure are computed using a constraint optimization.

A system and computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating outlier interpretation in an embodiment.

FIG. 2 is a flow diagram illustrating anomaly detection method selection and/or ranking in an embodiment.

FIG. 3 is a flow diagram illustrating model robustness determination and/or analysis in an embodiment.

FIG. 4 shows an example diagrams illustrating a contaminating process in an embodiment.

FIG. 5 illustrates a cloud-based system diagram in an embodiment.

FIG. 6 illustrates a user interface of a tool for performing outlier interpretation in an embodiment.

FIG. 7 illustrates a user interface of a tool for performing anomaly detection method ranking in an embodiment.

FIG. 8 illustrates a user interface of a tool for performing model robustness analysis in an embodiment.

FIG. 10 illustrates a schematic of an example computer or processing system that may implement a system according to one embodiment.

FIG. 11 illustrates a cloud computing environment in one embodiment.

FIG. 12 illustrates a set of functional abstraction layers provided by cloud computing environment in one embodiment of the present disclosure.

### DETAILED DESCRIPTION

Systems and methods can be provided in various embodiments, which can compute and provide, for example, display the influence or impact of outliers in time series, and support effective machine learning model selection among alternative models. In an aspect, a system in an embodiment may address the challenge of outlier interpretation in time series data via contamination processes. In an embodiment, the system may use an influence functional for time series data, which assumes that the observed input time series is obtained from separate processes for both the core input and the recurring outliers, that is, both the core process and the contaminating process. At each time stamp, with a defined or configured probability, the observed value of the contaminated process comes from the contaminating process, which corresponds to the outliers. In an embodiment, a comprehensive single-valued metric (referred to also as SIF or IFP) is determined to measure outlier impacts on future predictions. Such IFP can be suitable for machine learning models with a large number of parameters.

Due to the lack of labeled data, most outlier detection methods are unsupervised in nature. Thus, it is not easy to evaluate and select the best or desired outlier detection method for a given data and problem. The system in an embodiment can evaluate outlier detection method, e.g., based on the interpretation of outlier impacts on time series data by single-valued metric. A single-valued metric can provide theoretical insights to measure the impact of outliers on future predictions. In an embodiment, the system may model the observed time series data as a core process and a contaminating process, obtain outliers and core process using given outlier detection methods for time series data, obtain the influence of outliers on future predictions (e.g., a single-valued metric) and rank the outlier detection methods based on the single-valued metric. Robustness of a detection method such as a neural network can be determined. Based on determined robustness, a detection method such as a neural network can be retrained.

A system may include computer components and/or computer-implemented components, for instance, implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors. A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

The system in an embodiment can explain the influence of outliers in input time series to model parameter estimation and future predictions. The system in an embodiment can also model robustness evaluation based on the single-valued metrics. For example, the system may be able to evaluate robustness of a model given an occurrence of an outlier, e.g., the price of an equity “suddenly drops” by sell orders from a pool of investors or the price of an equity “suddenly rises” by buy orders. The system in an embodiment can also select the best anomaly detection methods. For example, industries such as but not limited to Internet of Things (IoT), healthcare, finance anomaly detection, and/or others, utilize anomaly detection methods. Anomaly or outliers can pose a challenge in data cleaning process, and can be considered an unsupervised problem in practice which presents challenges in selecting the suitable methods.

In an embodiment, the system can be a cloud-based system, but not limited to such. In an embodiment the system can interpret outliers in time series data in terms of impact of prediction parameters and future predictions, rank various outlier/anomaly detection methods, and evaluate model robustness by contaminating the input time series with outliers stochastically. The system in an embodiment utilizes a single-valued metric that characterizes the influence of outliers on time series data. A single-valued metric may overcome the limitation of influence functional that is a high-dimensional vector for complicated models (e.g., Long Short Term Memory) with many parameters. In an embodiment, a single-valued metric is given by the partial derivative of the predicted value with respect to the degree of the contaminating process (outliers), e.g., the sensitivity of the future predictions to the contaminating process (outliers) in the input time series. In an embodiment, the dynamic nature of the input time series is modeled by a stochastic replacing process, e.g., each observation at a given time stamp is originated by a core process and with a probability (e.g., small) from contaminating processes, i.e., outliers.

For time series data, certain types of outliers are intrinsically more harmful for parameter estimation and future predictions than others, irrespective of their frequency. The system and/or method in one or more embodiments determine the characteristics of such outliers through the lens of the influence functional from robust statistics. In an embodiment, the system, for example, considers the input time series as a contaminated process, with the recurring outliers generated from an unknown contaminating process. The system then leverages the influence functional to understand the impact of the contaminating process on parameter estimation, for example, machine learning models such as prediction models. The influence functional results in a multi-dimensional vector that measures the sensitivity of the predictive model to the contaminating process, which can be challenging to interpret especially for models with a large number of parameters. In an embodiment, the system uses a comprehensive single-valued metric (also referred to as SIF) to measure outlier impacts on future predictions. The SIF provides a quantitative measure regarding the outlier impacts, which can be used in a variety of scenarios, such as the evaluation of outlier detection methods, the creation of more harmful outliers, and/or others. The empirical results on multiple real data sets demonstrate the effectiveness of the single-valued metric.

Outlier analysis can be done for data cleaning, anomaly detection, gaining insights into the hidden patterns, and/or others. Detect outliers can be performed for static data or for dynamic data. In the dynamic settings, outliers often exhibit recurring patterns, which can be seen across multiple application domains, such as manufacturing process trace data, medical records, sensor data, time-evolving social network data, and/or others. It can be considered that the outliers follow an unknown contaminating process, which contributes to the observed input time series in a probabilistic way.

On the other hand, as machine learning techniques become an indispensable tool in many real applications, there are growing interests to gain insights into the working mechanism of machine learning models. Existing technique for providing explanations to black-box machine learning models focus on static data with feature representations. However, many high-impact application domains (e.g., security, finance) exhibit the time-evolving nature. The occasional outliers in the time series data can significantly affect the performance of the generated models, rendering the predicted future values not trustworthy. While there are outlier detection techniques for time series data, interpretation of the detected outliers (e.g., the recurrent ones) and their underlying generation mechanism is far from solved.

In one or more embodiments, a system and method provide outlier interpretation in time series data via contamination processes. For example, a system in an embodiment can start from the influence functional for time series data proposed, which assumes that the observed input time series is obtained from separate processes for both the core input and the recurring outliers, i.e., the core process and the contaminating process. At each time stamp, with a certain (small) probability, the observed value of the contaminated process comes from the contaminating process, which corresponds to the outliers. In an embodiment, the system may focus on the generic patchy outliers where the outlying patterns can be present over consecutive time stamps, and evaluate the impact of the contaminating process on both parameter estimation and future value prediction. In an embodiment, the system may include a single-valued metric (e.g., named SIF or IFP) to characterize the impact of the contaminating process on future predictions.

Gaining insights on such outlier impact can shed light on not only the relative performance of existing outlier detection techniques but also the type of outliers that a predictive model is robust/sensitive to. For example, the system can use the single-valued metric to determine or evaluate the performance of outlier detection techniques and also to determine the type of outliers to which a particular predictive model is robust or sensitive. Detected sensitivity of a predictive model such as a neural network can be used to retrain the neural network.

Examples implementations for outlier detection in time series can include k nearest neighbor (kNN) and k-means. Exemplary density-based methods include the kNN-CAD and angle-based outlier detection methods. Some deep learning-based approaches include auto-encoder, deep autoencoding Gaussian mixture model, and LSTM encoder-decoder and other neural network models. Due to the lack of labeled data, most outlier detection methods are unsupervised in nature. Temporal dynamics associated with time series and the low frequency of the recurring outliers characterizes time series data. In black-box models, such as Recurrent Neural Networks (RNN), the dimensionality of the model parameters can be very high. For instance, a basic RNN has n²+kn+nm parameters, where n, k and m denote the dimensionality of the hidden layer, output layer, and input layer, respectively. In such models, the interpretation in terms of the parameters may not be consumable by humans.

In an embodiment, a single-valued metric e.g., referred to as SIF or IFP, is provided to characterize the impact of the recurring outliers on future predictions. In an embodiment, the SIF is the partial derivative of the estimated model parameters or predicted values with respect to the degree of contamination. In other words, they measure the sensitivity of the predictive model/predictions to the contaminating process. Therefore, the SIF can be used to understand the impact of outliers regardless of the structure and degree of the contaminating processes or the types of predictive models.

In an embodiment, the system can provide or implement an approach for interpreting recurring outliers in time series data. The following description introduces the influence functional from robust statics and the contaminating process used to model the recurring outliers. The single-valued metric is also described for characterizing the impact of the contaminating process on future predictions, and its properties in various special cases.

Contaminating Processes

Let yᵢ^{γ} denote the observation of the input time series at time stamp i, where 0≤γ≤1 is a positive parameter controlling the contribution of the contaminating process to the input time series. It can be assumed that has the following definition.

yᵢ^{γ}=(1−zᵢ^{γ})xᵢ+zᵢ^{γ}ωᵢ (1)

where xᵢ and ωᵢ denote the observations at time stamp i from the core process (not contaminated by outliers) and the contaminating process (the outliers); zᵢ^{γ} denotes the observation at time stamp i from a 0-1 process with parameter γ such that P(zᵢ^{γ}=1)=γ+o(γ). In an aspect, zᵢ^{γ}=1 indicates that the observed value of the input time series at time stamp i is completely obtained from the contaminating process, and 0 indicates that the observed value is completely obtained from the core process. In an embodiment, it can be assumed that xᵢ, wᵢ, and zᵢ^{γ} are obtained from mutually independent processes, which are denoted μₓ, μ_{w}, and μ_{z}^{γ} respectively. Without loss of generality, it may be assumed that all these processes are ergodic and stationary.

In general, the 0-1 process zᵢ^{γ} captures the characteristics of the observed recurring outliers in the input time series. An example of the 0-1 process corresponds to the so-called patchy outliers, where zᵢ^{γ} with various values of time stamp i are highly correlated. More specifically, let \tilde{z}ᵢ^{q} denote independent and identically distributed (i.i.d.) binomial B(1,q) sequence, and zᵢ^{γ} depends on \tilde{z}ᵢ^{q} in the following way:

$${z}_{i}^{γ} = ( \begin{matrix}1 , & if {\tilde{z}}_{i - 1}^{q} = 1 for some l = 0 , 1 , … , k - 1 \\ 0 , & otherwise\end{matrix} \qquad ( 2 )$$

where k is a positive integer for the patch size and 0≤q≤1. Notice that when k=1, zᵢ^{γ}=\tilde{z}ᵢ^{q}, and the patchy outliers are reduced to independent outliers, i.e., zᵢ^{γ} is independent of zⱼ^{γ} for i≠j. Let γ=kq. Then it can be verified that P(zᵢ^{γ}=1)=kq+o(q), which is consistent with the requirement on the contaminating process from Eq. (1).

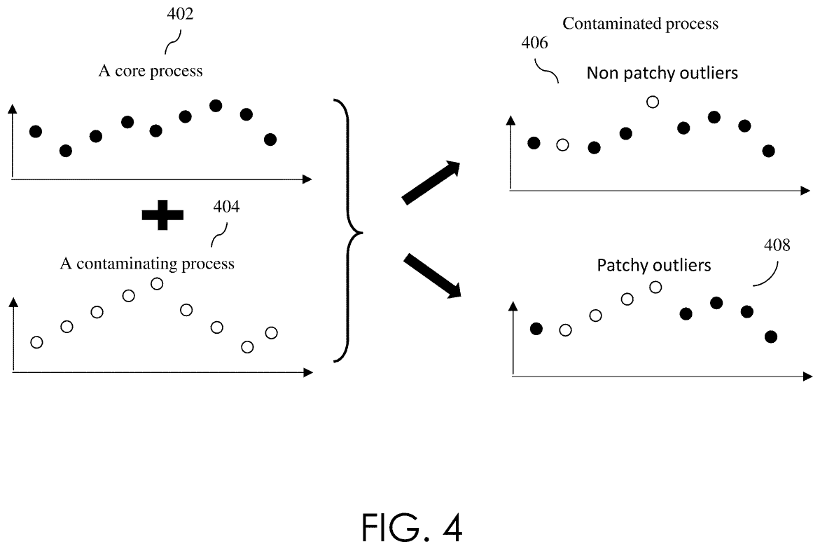

FIG. 4 shows an example diagrams illustrating a contaminating process in an embodiment. A contaminated process can have nonpatchy outliers and/or patchy outliers. A core process (xᵢ) 402 and a contaminating process (ωᵢ) 404 are shown, which can generate a contaminated process (yᵢ^{γ}=(1−zᵢ^{γ})xᵢ+zᵢ^{γ}ωᵢ, 0≤γ≤1), which can have non patchy outliers 406, and/or patchy outliers 408.

Influence Functional

Let θ∈ [symbol] ^{p} denote the vector of parameters involved in the predictive model of the input time series data, where p is the number of parameters. It can be estimated by solving the following equation.

∫\tilde{Ψ}(yᵢ^{γ},θ)dμ_{y}^{γ}=0 (3)

where \tilde{Ψ} denotes a function from [symbol] ^{∞}× [symbol] ^{p} to [symbol] ^{p} (e.g., first order derivative of the log-likelihood function), yᵢ^{γ} denotes the input time series up to time stamp i, and μ_{y}^{γ} denotes the process followed by yᵢ^{γ}. For the above equation, let OY denote its unique root, i.e., the optimal estimate of the model parameters.

Based on the above notation, the influence functional (IF) for time series data is defined as follows.

$$IF ( θ , \{ {μ}_{y}^{γ} \} ) = {lim}_{γ \to 0} \frac{{\hat{θ}}^{γ} - {\hat{θ}}^{0}}{γ} = \frac{d {\hat{θ}}^{γ}}{d γ} {\vert}_{γ = 0} \qquad ( 4 )$$

From the above definition, it can be seen that the influence functional (IF) is a p-dimensional vector measuring the impact of γ on the estimated parameters around γ=0, i.e., no outliers observed in the input time series. In other words, the influence functional depends on the intrinsic properties of the core process μₓ and the contaminating process μ_{ω}, irrespective of the frequency of outliers observed in the input time series. Eq. (4) shows sensitivity of model parameters to the input changes. In an aspect, the dim of IF increases with the number of parameters in the model and can be difficult to comprehend for interpretation purpose, especially for complex models with a large number of parameters. The following descriptions empirically demonstrate the influence functional associated with various types of the contaminating process for a specific input process. In general, the influence functional can be computed as follows.

Lemma 1 Under Mild Conditions, the Influence Functional can be Computed as Follows.

$$IF ( θ , \{ {μ}_{y}^{γ} \} ) = {lim}_{γ \to 0} \frac{- {E}_{y} ( {C}^{- 1} \tilde{Ψ} ( {y}_{i}^{γ} , {\hat{θ}}^{0} ) )}{γ} \qquad ( 5 )$$

where nonsingular p×p matrix

$$C = \frac{\partial {E}_{x} \tilde{Ψ} ( {x}_{i} , {\hat{θ}}^{0} )}{\partial θ} {\vert}_{θ = {\hat{θ}}^{0}} , {E}_{y} ( \cdot ) and {E}_{x} ( \cdot )$$

denote the expectation under the observed process μ_{y}^{γ} and the core process μₓ respectively, and xᵢ denotes the core time series up to time stamp i. C is the Hessian of the objective function for solving θ, e.g., the log-likelihood function.

Proof

It is shown that under mild conditions,

$$IF ( θ , \{ {μ}_{y}^{γ} \} ) = {lim}_{γ \to 0} \frac{E ( ICH ( {y}_{1}^{γ} ) )}{γ}$$

where ICH(y₁^{γ}) denotes the Hampel's influence curve with respect to γ.

Notice that the subscript i in Eq. (5) on the right hand side vanished because of stationarity of yᵢ^{γ}. C∈ [symbol] ^{p×p} is essentially the Hessian of the objective function for solving θ, e.g., the log-likelihood function. The inverse of C can be computationally expensive due to the high dimensionality of the parameter space, especially for deep neural networks. To address this problem, the system in an embodiment can adopt the implicit Hessian-Vector Products (HVPs) with stochastic estimation. Following the general method of computing the influence functional as shown in Lemma 1, the influence functional can enjoy a closed-form solution for certain classes of the underlying predictive model. Let ƒ(yᵢ₋₁^{γ},θ) denote the underlying model for predicting the observed value of input time series yᵢ^{γ} at time stamp i. The following lemma demonstrates the influence functional for a simple autoregressive model, i.e., an autoregressive AR(1) model given by ƒ(yᵢ^{γ},θ)=θyᵢ₋₁^{γ}, under patchy outliers with size k and γ=kq.

Lemma 2 for AR(1) Model with a Single Parameter θ, the Influence Functional of Patchy Outliers with Size k can be Computed as Follows.

$$IF ( θ , \{ {μ}_{y}^{γ} \} ) = \frac{1}{k {E}_{x} ( {x}^{2} )} ( - 2 {E}_{x} ( x ) {E}_{ω} ( ω ) - ( k - 1 ) {E}_{ω} ( {ω}_{0} {ω}_{1} ) + {\hat{θ}}^{0} {E}_{x} ( {x}^{2} ) + {\hat{θ}}^{0} k {E}_{ω} ( {ω}^{2} ) )$$

where E_{ω}(·) denotes the expectation under the contaminating process μ_{ω}, and E_{ω}(ω₀,ω₁) is the lag 1 autocorrelation of the outliers.

Notice that the analysis can be generalized to AR(n) models, i.e., ƒ(yᵢ^{γ},θ)=Σⱼ₌₁ⁿ θⱼyᵢ₋ⱼ^{γ} where θⱼ is the j^{th} element of θ, and is omitted for brevity here. From this lemma, there can be the following observations. First of all, when k=1, i.e., independent outliers, the influence functional is reduced to

$$IF ( θ , \{ {μ}_{y}^{γ} \} ) = \frac{- 2 {E}_{x} ( x ) {E}_{ω} ( ω ) + {\hat{θ}}^{0} {E}_{x} ( {x}^{2} ) + {\hat{θ}}^{0} {E}_{ω} ( {ω}^{2} )}{{E}_{x} ( {x}^{2} )}$$

On the other hand, when k goes to infinity (while γ=kp→0), the influence functional is reduced to

$$IF ( θ , \{ {μ}_{y}^{γ} \} ) {\to }^{k \to ∞} - \frac{{E}_{ω} ( {ω}_{0} {ω}_{1} )}{{E}_{x} ( {x}^{2} )} + \frac{{\hat{θ}}^{0} {E}_{ω} ( {ω}^{2} )}{{E}_{x} ( {x}^{2} )} \qquad ( 6 )$$

From the above equations, it can be seen that as k increases, the impact of the first-order moment from the contaminating process gradually decreases, and the impact of the second-order moment remains in the influence functional.

Influence on Future Predictions

Notice that the dimensionality of the influence functional increases with the number of parameters p in the model, and can be difficult to comprehend for interpretation purposes, especially for complex models with a large number of parameters. To address this problem, the system in an embodiment provides a single-valued metric based on the influence functional to characterize the impact of the contaminating process on future predictions. More specifically, let g(γ,θ) denote the expected predicted value of ƒ(yᵢ₋₁^{γ},θ) with respect to μ_{y}^{γ}, i.e., g(γ,θ): =E_{y}(ƒ(yᵢ₋₁^{γ},θ)). The following function provides for measuring the influence of the contaminating process on future predictions. SIF is also referred to as IFP.

$$SIF ( θ , \{ {μ}_{y}^{γ} \} ) := \frac{d}{d γ} g ( γ , {\hat{θ}}^{γ} ) {\vert}_{γ = 0} \qquad ( 7 )$$

Based on the above definition, SIF or IFP can be computed as follows.

$$SIF ( θ , \{ {μ}_{y}^{γ} \} ) = \frac{\partial g ( γ , {\hat{θ}}^{γ} )}{\partial γ} + \frac{( \partial g {( γ , θ )}^{′}}{\partial θ} \cdot \frac{d {\hat{θ}}^{γ}}{d γ} {\vert}_{θ = {\hat{θ}}^{γ} , γ = 0} = \frac{\partial g ( 0 , {\hat{θ}}^{0} )}{\partial γ} + \frac{\partial {g ( 0 , {\hat{θ}}^{0} )}^{′}}{\partial θ} \cdot IF ( θ , \{ {μ}_{y}^{0} \} ) \qquad ( 8 )$$

where

$$\frac{\partial }{\partial θ} g ( γ , θ )$$

is a p-dimensional vector, and

$$\frac{\partial }{\partial θ} {g ( γ , θ )}^{′}$$

is its transpose. The first term in Eq. (8) can represent a change due to contaminated input time series and the second term in Eq. (8) can represent a change due to parameter change induced by outliers in inputs.

In general, to compute the SIF, in addition to the influence functional, the system may also compute

$$\frac{\partial }{\partial γ} g ( 0 , {\hat{θ}}^{0} ) and \frac{\partial }{\partial θ} g ( 0 , {\hat{θ}}^{0} ) .$$

In an aspect,

$$\frac{\partial }{\partial θ} g ( 0 , {\hat{θ}}^{0} )$$

can be re-written as

$${E}_{x} ( \frac{\partial f ( {x}_{i - 1} , {\hat{θ}}^{0} )}{\partial θ} ) ,$$

where the partial derivation with respect to θ can be implemented in auto-grad systems such as TensorFlow, Torch and Theano. In an aspect,

$$\frac{\partial }{\partial γ} g ( 0 , {\hat{θ}}^{0} )$$

can be calculated based on the following lemma.

Lemma 3 for Patchy Outliers with Size k, we have

$$\frac{\partial g ( 0 , {\hat{θ}}^{0} )}{\partial γ} = \frac{1}{k} {E}_{x , w} [ {\sum }_{j = 1}^{i - 1} ( f ( {\tilde{y}}_{i - 1}^{( j )} , {\hat{θ}}^{0} ) - f ( {x}_{i - 1} , {\hat{θ}}^{0} ) ) ] \qquad ( 9 )$$

where \tilde{y}ᵢ₋₁^{(j)} is a vector with elements defined as follows

$${\tilde{y}}_{i - 1 , s}^{( j )} = ( \begin{matrix}{ω}_{s} , & if s = j + l for l = 0 , … , k - 1 \\ {x}_{s} , & otherwise\end{matrix}$$

Proof

For patchy outliers, the expectation over z^{γ} can be transferred to \tilde{z}^{p} and then expanded for small p values

$$\begin{matrix}\frac{\partial {E}_{z} γ [ f ( {y}_{i - 1}^{γ} , {\hat{θ}}^{0} ) ]}{\partial γ} {\vert}_{γ = 0} = \frac{1}{k} \frac{\partial }{\partial p} \\ {[ \begin{matrix}f ( {x}_{i ‐ 1} , θ ) {( 1 - p )}^{i - 1} + \\ {\sum }_{m = 1}^{i - 1} f ( {\tilde{y}}_{i - 1}^{( m )} , {\hat{θ}}^{0} ) {( 1 - p )}^{i - 2} p + o ( p )\end{matrix} ]}_{p = 0} \\ = \frac{1}{k} {\sum }_{m = 1}^{i - 1} [ f ( {\tilde{y}}_{i - 1}^{( m )} , \hat{θ} ) - f ( {x}_{i - 1} , θ ) ] .\end{matrix}$$

Substituting the above equation back to the expectation over x,ω yields Lemma 3.

Note that if the model does not have a long term memory, the summation terms with m<<i in Eq. (9) become 0s, suggesting the vanishing boundary effects. For AR(n) models, the following lemma shows the closed-form solution for the two partial derivatives in Eq. (8).

Lemma 4 For AR(n) models, we have

$$\frac{\partial }{\partial γ} g ( 0 , {\hat{θ}}^{0} ) = ( - {E}_{x} ( x ) + {E}_{ω} ( ω ) ) {\sum }_{j = 1}^{n} {θ}_{j} \\ \frac{\partial }{\partial θ} g ( 0 , {\hat{θ}}^{0} ) = {E}_{x} ( {[ {x}_{i - 1} , … , {x}_{i - n} ]}^{′} ) = {E}_{x} ( x ) {1}_{n}$$

where 1ₙ is a n×1 column vector consisting of all 1s.

Proof

For AR(n) models, the predictive model ƒ(yᵢ₋₁^{γ},θ)=θ·y_{(i-1):(i-n)}^{γ}, where · denotes the inner product between two vectors, and y_{(i-1):(i-n)}^{γ} denotes the observed input time series between time stamps i−1 and i−n. Therefore g(γ,θ)=Σⱼ₌₁ⁿ θⱼE_{y}(yᵢ₋₁^{γ})=Σⱼ₌₁ⁿ θⱼ((1−γ)Eₓ(x)+γE_{ω}(ω)). The lemma naturally follows by taking the partially derivative of g(0,\hat{θ}⁰) with respect to γ and θ.

Based on the above lemma, it can be seen that if Eₓ(x)=E_{ω}(ω), i.e., the core process and the contaminating process have the same mean, then

$$\frac{\partial }{\partial γ} g ( 0 , {\hat{θ}}^{0} ) = 0 ,$$

and the SIF is reduced to

SIF(θ{μ_{y}^{γ}})=Eₓ(x)1′ₙ·IF(θ,{μ_{y}⁰})

From the above equation, it can be seen that in this case, the impact of the contaminating process on future predictions is in proportion to the sum of all the elements in the influence functional.

Outlier Interpretation with SIF

Comparison of Outlier Detection Methods

A predictive model could be sensitive to different kinds of outliers. In an embodiment, the SIF measures the impact of the contaminating process on future predictions with a specific predictive model, regardless of the model type. Therefore, it can be used for outlier interpretation and evaluation of existing outlier detection methods. For example, given an outlier detection method and the observations that have been identified as outliers by this method from the input time series yᵢ^{γ}, the system may first estimate the contaminating process by estimating its moments as required by the computation of the influence functional for AR(n) models (e.g., Lemma 2), or by estimating the parameters of the contaminating process (e.g., RNN and Gaussian processes). Due to the low frequency of the outliers in general, there can be many missing values in ωᵢ. For the purpose of estimating the parameters of the contaminating process with patchy outliers enabled by zᵢ^{γ}, the system may first divide the entire time series into multiple sub-series such that each sub-series will consist of one or a few sequences of patchy outliers. Then the system can use various filtering techniques to estimate the parameters of the contaminating process. The value of γ can be roughly estimated by the percentage of the outliers in the entire input time series. k the patch size can be obtained by solving Eq. (10) in Lemma 5 using e.g., Newton's method, where E_{z}^{γ}(L) can be estimated by the average number of consecutive time stamps of patchy outliers. Note that the root to Eq. (10) might not be unique due to its nonlinearity. In an embodiment, a rule may follow that reasonable k values should be less than but close to E_{z}^{γ}(L) when γ is small.

The system can estimate both the influence functional and the SIF numerically by gradually reducing γ to 0, or probabilistically removing some identified outliers and replacing them by the predicted values from the underlying model of the core process. In an embodiment, following the same procedure, the system may obtain the SIF of various outlier detection methods. In an aspect, larger SIF values indicate that the outliers have a higher impact on future predictions, and thus the corresponding detection method is able to identify the more prominent outliers.

Lemma 5 for Generic Patchy Outliers, the Expected Number of Consecutive Time Stamps in a Patch is Given by

$${E}_{z}^{γ} ( L ) = k + \frac{{k}^{k + 1} - ( γ + 1 ) {( k - γ )}^{k} k}{{γ ( k - γ )}^{k}} . \qquad ( 10 )$$

Proof

Suppose that a patch of outliers start at a time stamp i, i.e. zᵢ^{γ}=1 and if i>0, then zᵢ₋₁^{γ}=0. This suggests that \tilde{z}ᵢ^{q}=1 based on Eq. (2). Let A=l denote the number of time stamps until the next \tilde{z}^{q}=1, i.e., \tilde{z}ᵢ₊ⱼ^{q}=0 for j=1, . . . , l and \tilde{z}ᵢ₊ₗ^{q}=1. If l>k, then the patch length equals k; otherwise, it can be computed by adding l to the expected patch length starting from time stamp i+l, which is again E_{z}^{γ}(L) due to symmetry. Therefore, the expected patch size can be analyzed as an iterative equation given by

E_{z}^{γ}(L)=(1+E_{z}^{ã}(L))P(A=1)+(2+E_{z}^{γ}(L))P(A=2)+ . . . +(k+E_{z}^{γ}(L))P(A=k)+kP(A>k).

Since \tilde{z}ᵢ^{q}=0 follows i.i.d binomial B(1,q), A follows a geometric distribution with parameter q. Solving E_{z}^{γ}(L) leads to Eq. (10).

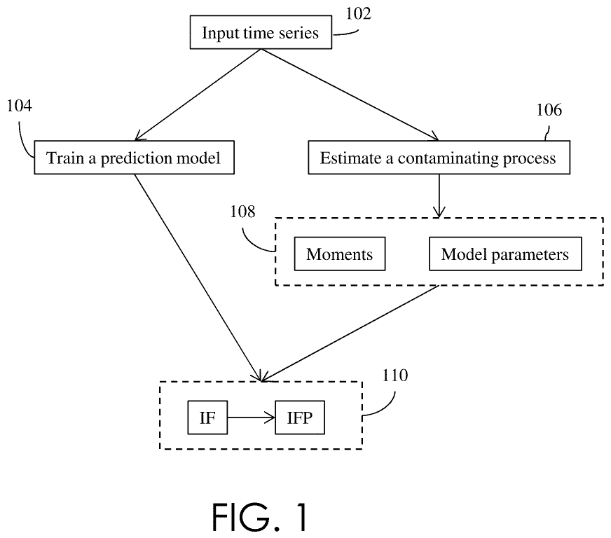

FIG. 1 is a flow diagram illustrating outlier interpretation method in an embodiment. The method can be implemented and/or run on one or more computer processors, for example, including hardware processors. One or more hardware processors, for example, may include components such as programmable logic devices, microcontrollers, memory devices, and/or other hardware components, which may be configured to perform respective tasks described in the present disclosure. At 102, input time series data is received. At 104, given the input time series data, a prediction mode such as, but not limited to, a neural network is trained to make future predictions.

At 106, given an outlier detection method and the observations that have been identified as outliers by this method from the input time series yᵢ^{γ} (e.g., at 102), the method can include estimating a contaminating process. For example, estimating the contaminating process can include estimating its moments 108, for example, as required by the computation of the influence functional for AR(n) models, and/or by estimating the parameters of the contaminating process (e.g., RNN and Gaussian processes) 108. Due to the low frequency of the outliers in general, there can be many missing values in w₁. In an embodiment, to estimate the parameters of the contaminating process with patchy outliers enabled by zᵢ^{γ}, the method may include dividing the entire time series into multiple sub-series such that each sub-series includes one or a few sequences of patchy outliers. Then the method can perform one or more filtering techniques to estimate the parameters of the contaminating process. The value of γ can be roughly estimated by the percentage of the outliers in the entire input time series.

At 110, the method includes estimating both the influence functional (IF) and the SIF (also referred to as IFP) numerically by gradually reducing γ to 0, or probabilistically removing some identified outliers and replacing them by the predicted values from the underlying model of the core process. Estimating IF and SIF is described above in detail. In an embodiment, SIFs of various outlier detection methods can be obtained, for example, by repeating the method using different outlier detection methods at 106. In an aspect, larger IF/IFP values indicate that the outliers have a higher impact on model parameters/future predictions, and can be more harmful.

Crafting Adversarial Contaminating Processes (ACP)

Adversarial attacks may pose an inherent weakness of machine learning models. In an embodiment, the SIF can be applied to craft adversarial contaminating processes (ACP) that can shed light on model vulnerability as well as the type of outliers that a predictive model is robust/sensitive to. ACP herein refers to identifying a contamination process, e.g., the best contamination process that will impact the parameter estimates/predictions to the largest degree without raising suspicion, i.e., the core process and the contaminating process have the same first two moments. To craft ACP, the system in an embodiment finds the best contaminating time series structure (e.g. AR(n) or RNN) and then estimates the optimal parameters for the data structure. In an aspect, these two steps can be entangled, but can be split into two for ease of illustration.

In an aspect, the system may quantitatively evaluate the influence functional (IF) and the SIF with respect to the impact of the contaminating process on the parameter estimation and future predictions. The system may also use the SIF for evaluating outlier detection methods and crafting adversarial contaminating processes.

Experimental Results

Analysis of Influence Functional and SIF

The IF/SIF is generally applicable to any contaminating processes that are ergodic and stationary, as well as any kinds of predictive models. For the sake of presentation clarity as the dimensionality of the IF increases with the number of parameters, an AR(1) model with a single parameter θ can be used as the core process in the following experiments. The IF is approximated by the slope of \hat{θ}^{γ} with respect to γ. The SIF is given by the slope of g(γ,\hat{θ}^{γ}) over a set of γ values passing (0,g(0,\hat{θ}⁰)), where g(γ,\hat{θ}^{γ}) is estimated by the average of the first out-of-sample prediction. The parameter γ controls the contribution of the contaminating process to the input time series. The experiment can set the coefficient of the core process as 0.7 and γ∈[0,0.01]. Similar results can be observed with other coefficients and thus the results with this specific value are presented herein. The same can be applied to other experiments. The setting of contaminating processes, patchy size k and predictive models in below experiments are given in Table 1. Following Eq. (1), the system may obtain the contaminated time series which is used to train the predictive models and estimate \hat{θ}^{γ} and g(γ,\hat{θ}^{γ}) over a set of γ values. The system may repeat the simulation can be repeated 50 times and 1000 times for analysis of the IF and the SIF, respectively, and calculate the mean and variance of the parameter estimation. First, the system may evaluate the IF with respect to k, the parch size of outliers. The results can be compared together with the theoretical IF values for the given predictive model. It can be observed that: (1) \hat{θ}^{γ} linearly depends on γ and matches its theoretical value in the studied range; (2) as k increases, the rate of linear dependency (i.e., the IF) decreases as suggested by Eq. (6). Second, the system may compare different contaminating processes, i.e., i.i.d. N(0,1) and AR(1) with coef. −0.5. It is shown that the influence of the auto-correlated contaminating process is larger than white noise for patchy outliers. These studies verify the implication of Lemma 2. Third, the system may compare the SIF for predictive models AR(1) and RNN. It can be shown that the SIF of the RNN model is larger than that of the AR(1) model, indicating that a simple AR(1) predictive model is more robust than the RNN model.

TABLE 1
Experiment Setting for Analysis of IF and SIF

| | Contaminating | Patch | Predictive |
|---|---|---|---|
| Exp | process | size, k | model |
| 1^{st} | i.i.d. N(0, 1) | 1, 2, 3 | AR(1) |
| 2^{nd} | i.i.d. N(0, 1) | 3 | AR(1) |
| | AR(1), coef. −0.5 | | |
| 3^{rd} | i.i.d. N(0, 1) | 3 | AR(1), RNN |

Evaluation of Outlier Detection Methods

In an embodiment, the system can perform an evaluation of outlier detection methods for time series data using the SIF. In practice, this evaluation can facilitate the identification of the most influential outliers and the selection of robust machine learning techniques for time series forecasting. In various embodiments, the technique is not restricted to any type of outlier detection methods.

Data

In an embodiment, the evaluation can be based on three data sets: synthetic, semi-synthetic, and electrocardiography (ECG) data, where true outliers are known. In an aspect, actual outlier labels are not required by using the SIF to evaluate outlier detection methods. However, such labels can allow the system to verify the effectiveness of using the SIF to compare various outlier detection methods. The synthetic data is created using an AR(2) model with coefficients (0.7,−0.3) as the core time series, an AR(1) with a coefficient 0.5 as the contaminating process, k=5, and γ=0.3. By way of example, for the semi-synthetic data, a clean time series, real_35, can be randomly selected from an existing data and contaminated in the same way as the synthetic data. The original ECG data can be obtained from another existing data. For example, the data can be processed as follows: 1) each heartbeat is extracted and made equal length via interpolation; 2) normal seasonal signal is removed from the obtained time series using the Holt-Winters' additive method; 3) the residual time series is labeled as normal/abnormal heartbeats.

Setup

Available data and anomaly detection methods in streaming applications can be used as examples. Examples of detection methods used can include: 1) Random: randomly selected outliers; 2) EXPoSe: distance-based; 3) Windowed Gaussian: distribution-based; 4) Bayesian online Changepoint: distribution-based; 5) KNN CAD: combination of density- and distance-based; 6) Numenta: prediction-based; 7) Numenta HTM: rule- and prediction-based. For fairness, the thresholds are chosen such that all the methods return the actual number of outliers.

By way of example, the system can use three ranking metrics, e.g., the magnitude of SIF for a specific predictive model (AR(2) or RNN), Precision (Prec.) of identified outliers and the Similarity (Sim.) of model parameters. The Sim. is calculated based on 1/(1+d) where d denotes the Euclidean distance between the real and the estimated parameters using cleaned data based on the results from various outlier detection methods.

Ranking Result

The ranking results show that for the AR(·) predictive models, the relative ranking of various outlier detection methods based on the magnitude of the SIF matches perfectly to that of Prec. and the \hat{θ} Sim. based on the synthetic data and is consistent for the semi-synthetic data and ECG data as well. For the RNN predictive model, the ranking results based on the SIF are also largely consistent with Prec. and the \hat{θ} Sim. for all the data sets. To further quantify the ranking similarity of different criteria, a report of the Kendall's Tau coefficient is shown in Table 2, where all the coefficients are positive. This confirms the ranking consistency between the SIF without outlier labels and other metrics utilizing outlier labels.

TABLE 2
Kendall's Tau Coefficient Summary

| Data | Model | SIF & Prec. | SIF & \hat{θ} Sim. |
|---|---|---|---|
| Synth | AR(2) | 0.50 | 1.00 |
| Synth | RNN | 0.43 | 0.36 |
| Semi-Synth | AR(2) | 0.43 | 0.71 |
| Semi-Synth | RNN | 0.21 | 0.43 |
| ECG | AR(3) | 0.43 | 0.14 |
| ECG | RNN | 0.29 | 0.64 |

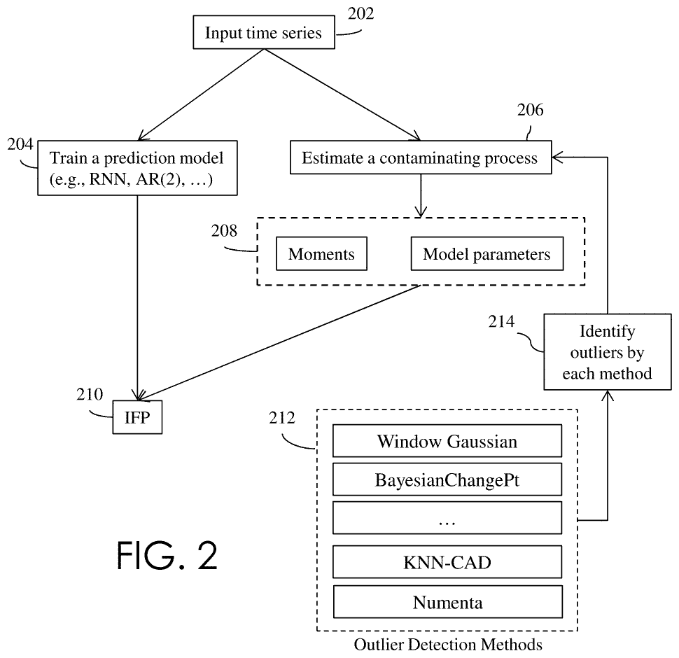

FIG. 2 is a flow diagram illustrating anomaly detection method selection and/or ranking in an embodiment. At 202, input time series data is received. At 204, given the input time series data, a prediction mode such as, but not limited to, a neural network is trained to make future predictions.

At 206, given an outlier detection method 212 and the observations that have been identified as outliers by this method 214 from the input time series yᵢ^{γ} (e.g., at 102), the method can include estimating a contaminating process, for instance, as described above. At 214, e.g., a given outlier detection method run to identify outliers. The methods 212 can include trained machine learning models. Estimating the contaminating process at 206 can include estimating its moments 208, for example, via the computation of the influence functional for AR(n) models, and/or by estimating the parameters of the contaminating process (e.g., RNN and Gaussian processes) 208, e.g., as described above.

At 210, the method includes determining the IFP or SIF associated with the given outlier detection method, for example, as described above. In an embodiment, SIFs of various outlier detection methods can be obtained, for example, by repeating the method using different outlier detection methods 210. For instance, for each of the plurality of the detection methods 210, the processing at 206, 208 and 210 can repeat for a trained prediction model. Such process can also repeat for different trained prediction models, for example, at 204. For example, for each of different trained prediction models, a plurality of SIF associated with a plurality of contaminating processes respectively (each contaminating process associated with a different outlier detection method) can be computed.

In an embodiment, the method can include ranking the outlier detection methods according to the associated SIFs computed at 210. For instance, larger IFP or SIF values indicate that the outliers have a higher impact on future predictions for a given prediction model, and thus the corresponding detection method is able to identify the more prominent outliers. In an embodiment, the method allows for determining which type of, or what anomaly detection method is effective for which type of, or what prediction mode. For example, anomaly detection method effective for RNN prediction model can be ranked as: #1. Numenta, IFP=0.82; #2. Window Gaussian, IFP=0.67; #3. kNN-CAD, IFP=0.58. As another example, detection method effective for AR(2) prediction model can be ranked as: #1. kNN-CAD, IFP=0.78; #2. BayesianChangePt, IFP=0.72; #3. Window Gaussian, IFP=0.63.

Crafting Adversarial Contaminating Processes

The system in an embodiment can use the SIF to craft adversarial contaminating processes (ACP) with the most influence on future predictions and provide insights into the type of outliers that a predictive model is robust/sensitive to. For example, for experimentation, the system can use the real_35 data as the core time series, split it into train and test (60:40) sets sequentially, normalize the train set to mean 0 and standard deviation 1, and train an LSTM predictive model.

It can be illustrated that the SIF can be applied to select the structure of contaminating time series that a predictive model is most vulnerable to. The system can set k=1 and generate contaminating processes using autoregressive moving-average (ARMA) model, two layers RNN, and LSTM, which are used to compute the corresponding SIF values. For example, to be specific, the system can randomly select the coefficients for the ARMA(2, 2) model under the constraint of the stationary triangle, and choose the LSTM and RNN models with two layers and 256 hidden states. Given the trained LSTM predictive model, the maximum absolute SIF value is obtained from the ARMA(2, 2) model, as shown in Table 3. This implies that in this specific setting and given data structures, the LSTM predictive model is most sensitive to the ARMA type of outliers. To validate this observation, further experiments can be conducted. For instance, the system may randomly contaminate the train set with 10% outliers using the same data structures. Given the contaminated train sets, the system may retrain the LSTM models and obtain their root mean square error (RMSE) on the uncontaminated test data. The system may fix the contaminating process parameters and repeat the experiment 100 times, the mean and the standard deviation of the RMSEs are reported in Table 3. It can be observed that the SIF values increase with the RMSEs, and the maximum SIF and RMSE correspond to the same contaminating process, ARMA.

Following the above experiments, it can be illustrated the SIF values can be used to seek the optimal ARMA parameters that can contaminate the core process with the most adversarial influence on future predictions and raise no suspicion. For example, the system may determine the optimal ARMA coefficients by maximizing the SI F² under the constraint of the stationary triangle. In an aspect, the system may solve the constrained optimization problem using SLSQP, a standard package available in Python. To avoid suspicion, during each optimization iteration, the generated contaminating time series is scaled to have the same mean and standard deviation as the core process. The system obtains coefficients [(0.563,0.437), (5.55,1.829)]. To validate this set of ARMA coefficients leads to the most influential ACP with respect to the LSTM predictive model, the system may randomly select the coefficients as before and repeat 100 times. For the 100 sets of contaminating process parameters, again the system may obtain their corresponding RMSEs in the test set and report the mean and standard deviation over a range of γ value. It can be shown that the RMSE of the ARMA model with the optimal coefficients is consistently larger than that of the randomly selected coefficients on average.

TABLE 3
Comparison of ACP

| ACP | \| SIF\| | RMSE |
|---|---|---|
| ARMA(2, 2) | 0.4263 | 0.7628 ± 0.0098 |
| Two-Layer STM | 0.3203 | 0.7516 ± 0.0169 |
| Two-Layer RNN | 0.1184 | 0.7431 ± 0.0098 |

The system and/or method in one or more embodiments determine and/or evaluate recurring outliers in time series data and provide a systematic way of measuring the impact of such outliers on time series analysis. The system and/or method, in an embodiment, use the contaminated process to model the input time series. At each timestamp, the observation has a small probability of coming from the contaminating process, i.e., the outliers. Then system and/or method introduce the influence functional from robust statistics to quantify the impact of the contaminating process on the parameter estimation. For outlier interpretation and evaluation of existing outlier detection methods, the system and/or method provide a single-valued metric named the SIF or IFP to characterize the impact of the contaminating process on future predictions, and analyze its properties from various aspects. In one or more embodiments, the techniques can be extended to multivariate time series analysis. Experimental results demonstrate the proposed approach from various aspects, including, for example, for the use of evaluating existing outlier detection methods and crafting ACP.

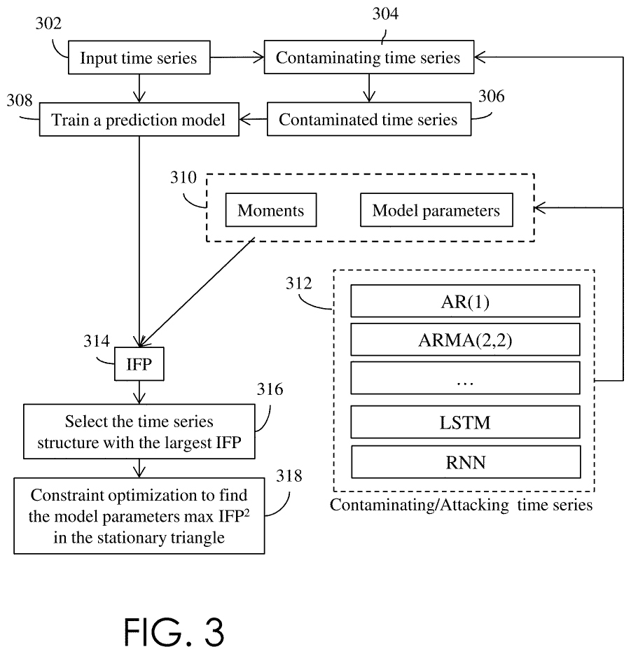

FIG. 3 is a flow diagram illustrating model robustness determination and/or analysis in an embodiment. At 302, input time series is received. At 304, contaminating time series is generated. For example, the method may include generating contaminating processes using models, e.g., autoregressive moving-average (ARMA) model, RNN and LSTM, e.g., shown at 312. At 306, contaminated time series is generated using the input time series and the contaminating time series. The contaminated time series contains the input time series contaminated with outliers, e.g., generated by a model at 312. At 308, a prediction model (e.g., LSTM or another model) is trained using the contaminated time series. At 310, moments and/or model parameters associated with the contaminating process 312 can be determined or computed. At 314, IFP (also referred to as SIF) value corresponding to the contaminating process can be determined or computed, for example, as described above. The method can be repeated for each of the contaminating process models shown at 312. At 316, the time series structure (e.g., one of structures shown at 312) with the largest IFP is selected. Large IFP can signal less robustness to the added type of outliers. At 318, optimal parameters can be estimated for the selected structure. For example, constraint optimization can be performed to find the model parameters of the selected structure. At 316 and 318, criteria such as small training error and largest testing error can be considered.

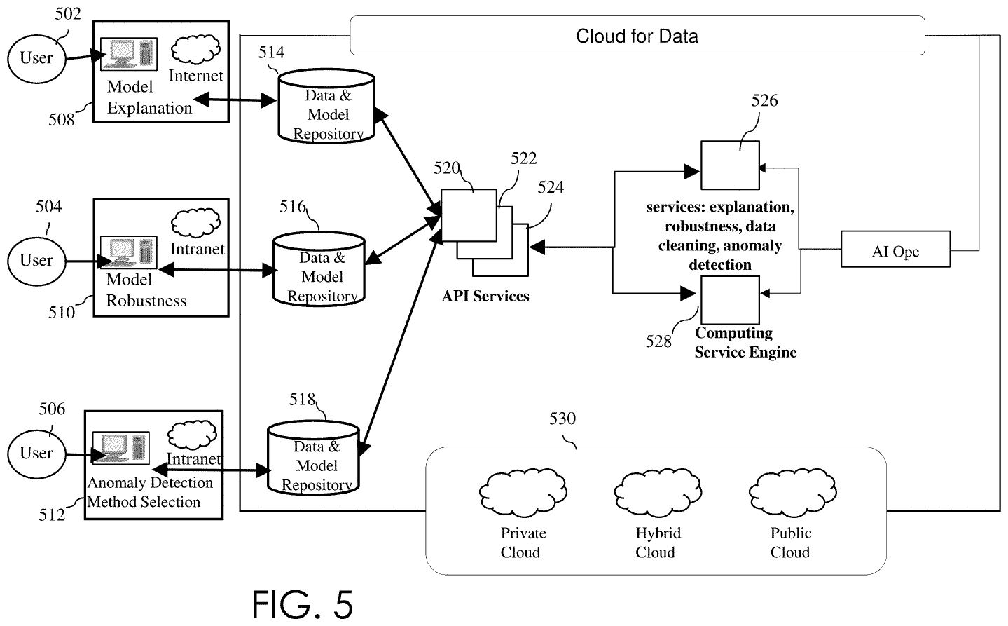

In an embodiment, the model explanation, robustness detection and anomaly detection method selection, for example, described above, can be implemented and provided in a cloud-based tool with one or more application programming interfaces (APIs). FIG. 5 illustrates a cloud-based system diagram in an embodiment. Users 502, 504, 506 may access the functionalities of the tool via a user interface and network, e.g., intranet and/or internet 508. 510, 512. Data and model repositories 514, 516, 518 can store input and output data, and also a plurality of machine learning models. API services 520, 522. 524 provide interfaces to services 526 for model explanation, robustness, data cleaning, and anomaly detection. A computing service engine 528 works with the services 526 in providing requested functionalities. The cloud-based system can be different types of cloud, e.g., as shown at 530. For instance, AI explanation and robustness library for time series data can include the following functionalities: outlier interpretation, model robustness analysis and anomaly detection method ranking.

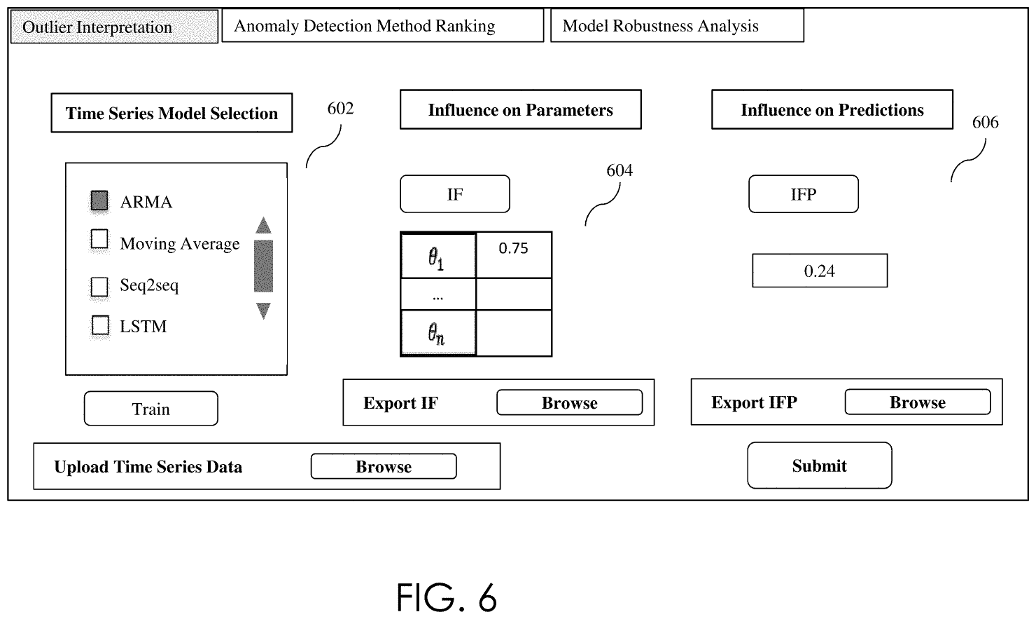

FIG. 6 illustrates a user interface of a tool for performing outlier interpretation in an embodiment. The user interface, for example, can be run on a user machine (e.g., shown at 508. 510, 512 in FIG. 5), which can include communication or network capabilities, for instance, for connecting and communicating with one or more API services on a remote system. The display screen of the user interface shows an interface for performing outlier interpretation or explanation functionality. A time series model can be selected and trained as shown 602. Outliers' influence on parameters (IF) can be computed and displayed as shown at 604. Outliers' influence on predictions (IFP) can be computed and displayed as shown at 606.

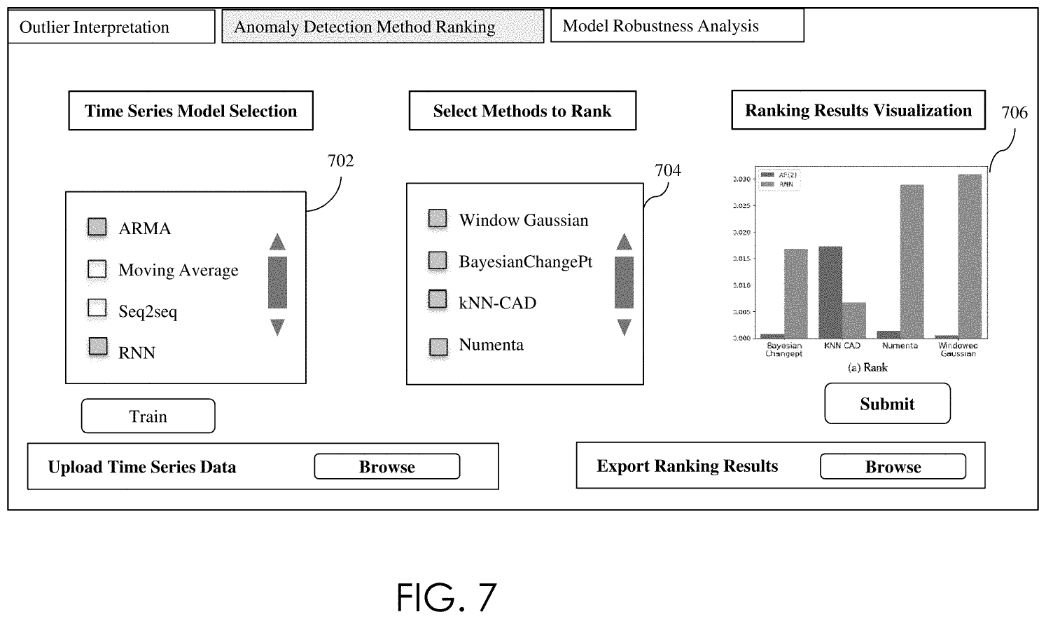

FIG. 7 illustrates a user interface of a tool for performing anomaly detection method ranking in an embodiment. The user interface, for example, can be run on a user machine (e.g., shown at 508. 510, 512 in FIG. 5), which can include communication or network capabilities, for instance, for connecting and communicating with one or more API services on a remote system. The display screen of the user interface shows an interface for performing anomaly detection method ranking functionality. A time series model can be selected and trained as shown 702. Methods to rank can be selected as shown at 704. Ranking results can be visualized and presented or displayed as shown at 706.

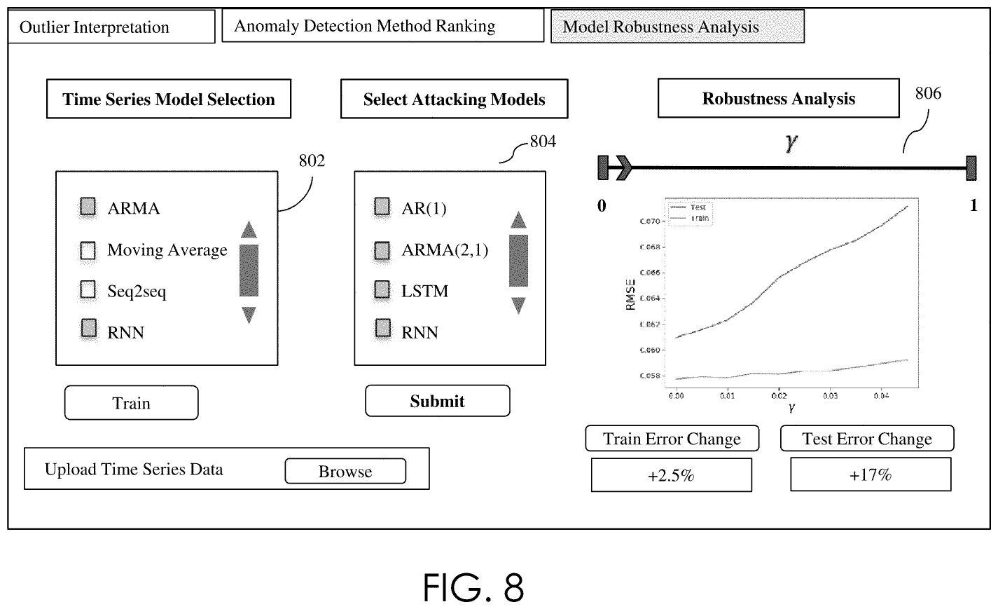

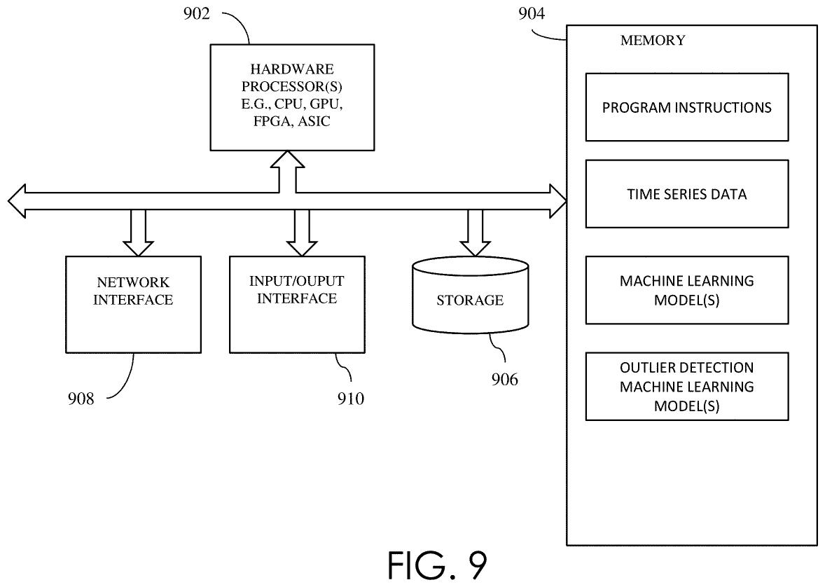

FIG. 8 illustrates a user interface of a tool for performing model robustness analysis in an embodiment. The user interface, for example, can be run on a user machine (e.g., shown at 508. 510, 512 in FIG. 5), which can include communication or network capabilities, for instance, for connecting and communicating with one or more API services on a remote system. The display screen of the user interface shows an interface for performing model robustness analysis functionality. A time series model can be selected and trained as shown 802. Attacking methods can be selected as shown at 804. Robustness analysis can be visualized and presented or displayed as shown at 806.

For time series data, certain types of outliers are intrinsically more harmful for parameter estimation and future pre-dictions than others, irrespective of their frequency. The system in an embodiment considers the input time series as a contaminated process, with the recurring outliers generated from an unknown contaminating process and the system leverages the influence functional to understand the impact of the contaminating process on parameter estimation. The influence functional results in a multi-dimensional vector that measures the sensitivity of the predictive model to the contaminating process, which can be challenging to interpret especially for models with a large number of parameters. A comprehensive single-valued metric (also referred to as an IFP) is provided to measure outlier impacts on future predictions. It provides a quantitative measure regarding the outlier impacts, which can be used in a variety of scenarios, such as the evaluation of outlier detection methods, the creation of more harmful outliers to shed lights on model robustness, and/or others.

The system and method in one or more embodiments can explain outliers for time series modeling. A single-valued metric is provided to characterize the influence of outliers in time series to future predictions. The single-valued metric can overcome the limitation of influence functional, e.g., a high-dimensional vector for complicated models (e.g., LSTM) with many parameters, for the purpose of comprehension interpretation. The single-valued metric can be leveraged to evaluate and select outlier detection methods. The system and/or method can provide insights on model robustness to adversarial attacks in application domains such as, but not limited to, energy distribution or cloud resource allocation. The system and/or method can also work for data cleaning, AI explanation and AI robustness, model risk monitoring, explanation of outlier impact, and/or anomaly model selection. The system and/or method can improve model explanation in dynamic setting, evaluate model robustness in dynamic setting, and evaluate and select unsupervised anomaly or like detection models.

Outliers in time series data create contaminated input time series. Existence of outliers in time series data, for example, used as training data set for training machine learning models such as neural networks may produce unreliable estimation of model parameters, for example, at model development time. Consequently, models so trained can output unreliable future predictions, for example, at model execution time. Improvements to model development and execution, for example, deep learning models, neural networks, LSTM, RNN and/or other, can be provided herein. In an aspect, the outlier interpretation provided herein can contribute to AI explanation and provide a dimension of machine learning model use risk. Ability to compare outlier detection methods so that one can be chosen for use at runtime can also be provided. Model robustness functionality allows for recognizing outlier transactions types that impact a given model most and can contribute to AI robustness detection.

FIG. 9 is a diagram showing components of a system in one embodiment that can explain outliers in time series and evaluate anomaly detection methods. The system can also generate or craft adversarial processes. One or more hardware processors 902 such as a central processing unit (CPU), a graphic process unit (GPU), and/or a Field Programmable Gate Array (FPGA), an application specific integrated circuit (ASIC), and/or another processor, may be coupled with a memory device 904, and perform outlier impact analysis. A memory device 904 may include random access memory (RAM), read-only memory (ROM) or another memory device, and may store data and/or processor instructions for implementing various functionalities associated with the methods and/or systems described herein. One or more processors 902 may execute computer instructions stored in memory 904 or received from another computer device or medium. A memory device 904 may, for example, store instructions and/or data for functioning of one or more hardware processors 902, and may include an operating system and other program of instructions and/or data. One or more hardware processors 902 may receive input including times series data. At least one hardware processor 902 may train a machine learning model using the time series data. At least one hardware processor 902 may estimate a contaminating process based on the time series data, the contaminating process including outliers associated with the time series data. At least one hardware processor 902 may determine a parameter associated with the contaminating process. At least one hardware processor 902 may, based on the trained machine learning model and the parameter associated with the contaminating process, determine a single-valued metric representing an impact of the contaminating process on the machine learning model's future prediction. In one aspect, input times series data and machine learning models, and/or outlier detection methods may be stored in a storage device 906 or received via a network interface 908 from a remote device, and may be temporarily loaded into a memory device 904 for performing one or more functions described herein. One or more hardware processors 902 may be coupled with interface devices such as a network interface 908 for communicating with remote systems, for example, via a network, and an input/output interface 910 for communicating with input and/or output devices such as a keyboard, mouse, display, and/or others.

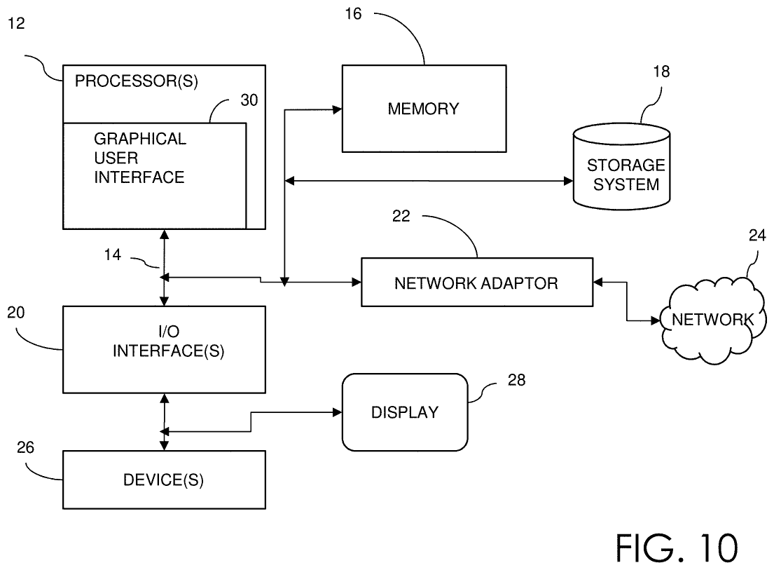

FIG. 10 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 10 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being run by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

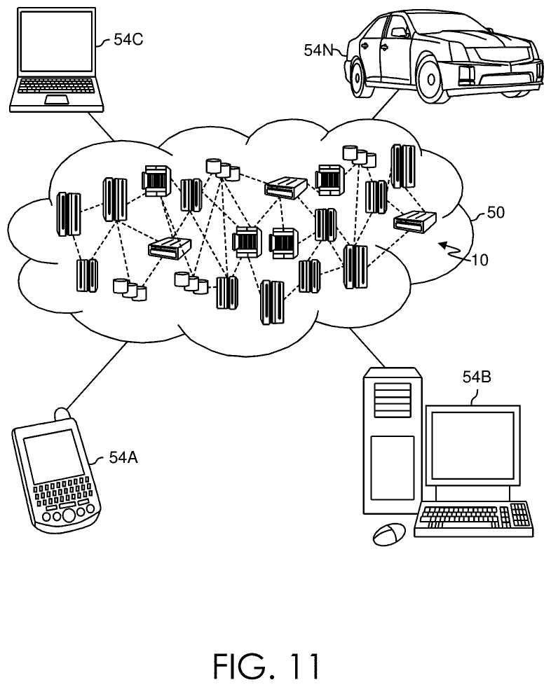

Referring now to FIG. 11, illustrative cloud computing environment 50 is depicted. As shown, cloud computing environment 50 includes one or more cloud computing nodes 10 with which local computing devices used by cloud consumers, such as, for example, digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

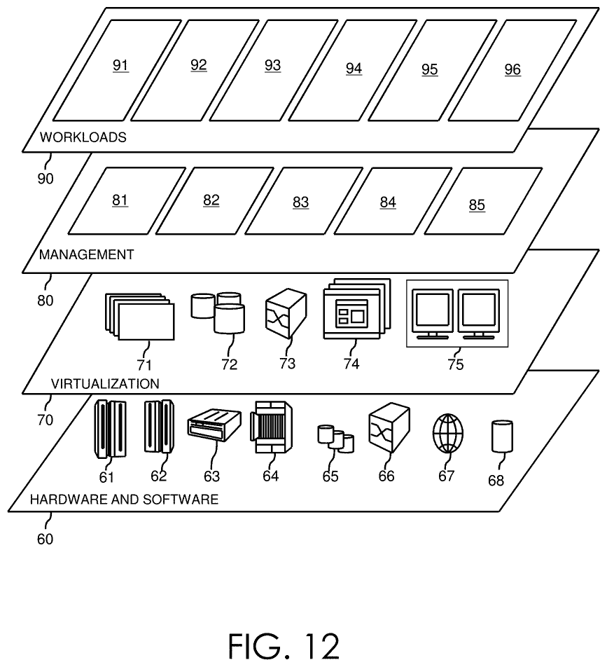

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and outlier in time series processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving time series data;
training a machine learning model using the time series data;
estimating a contaminating process based on the time series data, the contaminating process including outliers associated with the time series data;
determining a parameter associated with the contaminating process; and
based on the trained machine learning model and the parameter associated with the contaminating process, determining a single-valued metric representing an impact of the contaminating process on the machine learning model's future prediction.

2. The method of claim 1, wherein the single-valued metric is determined as a function of a change due to contaminated input time series and a change due to parameter change induced by outliers in the time series data.

3. The method of claim 1, wherein the parameter associated with the contaminating process is determined as the contaminating process's moments associated with an influence functional for the machine learning model.

4. The method of claim 1, wherein the parameter associated with the contaminating process is determined as parameters of the contaminating process.

5. The method of claim 1, wherein a plurality of different outlier detecting machine learning models is used to estimate the contaminating process and the single-valued metric is determined for each of the plurality of different outlier detecting machine learning models, wherein the plurality of different outlier detecting machine learning models is ranked according to the associated single-valued metric.

6. The method of claim 1, wherein a type of the machine learning model to train is configurable.

7. The method of claim 1, wherein the machine learning model includes a neural network model.

8. The method of claim 1, wherein the estimating the contamination process include generating the contamination process using a plurality of different machine learning structures, wherein a plurality of single-valued metrics are generated associated with the plurality of different machine learning structures respectively, wherein a machine learning structure is selected from the plurality of different machine learning structures based on the associated single-valued metric, and model parameters for the selected machine learning structure are computed using a constraint optimization.

9. A computer program product comprising a computer readable storage medium having program instructions embodied therewith, the program instructions readable by a device to cause the device to:
receive time series data;
train a machine learning model using the time series data;
estimate a contaminating process based on the time series data, the contaminating process including outliers associated with the time series data;
determine a parameter associated with the contaminating process; and
based on the trained machine learning model and the parameter associated with the contaminating process, determine a single-valued metric representing an impact of the contaminating process on the machine learning model's future prediction.

10. The computer program product of claim 9, wherein the single-valued metric is determined as a function of a change due to contaminated input time series and a change due to parameter change induced by outliers in the time series data.

11. The computer program product of claim 9, wherein the parameter associated with the contaminating process is determined as the contaminating process's moments associated with an influence functional for the machine learning model.

12. The computer program product of claim 9, wherein the parameter associated with the contaminating process is determined as parameters of the contaminating process.

13. The computer program product of claim 9, wherein a plurality of different outlier detecting machine learning models is used to estimate the contaminating process and the single-valued metric is determined for each of the plurality of different outlier detecting machine learning models, wherein the plurality of different outlier detecting machine learning models is ranked according to the associated single-valued metric.

14. The computer program product of claim 9, wherein a type of the machine learning model to train is configurable.

15. The computer program product of claim 9, wherein the machine learning model includes a neural network model.

16. The computer program product of claim 9, wherein the device is caused to create an adversarial contaminating process by generating the contamination process using a plurality of different machine learning structures, wherein a plurality of single-valued metrics are generated associated with the plurality of different machine learning structures respectively, wherein a machine learning structure is selected from the plurality of different machine learning structures based on the associated single-valued metric, and model parameters for the selected machine learning structure are computed using a constraint optimization.

17. A system comprising:
a processor;
a memory device coupled with the processor;
the processor configured to at least:
receive time series data;
train a machine learning model using the time series data;
estimate a contaminating process based on the time series data, the contaminating process including outliers associated with the time series data;
determine a parameter associated with the contaminating process; and
based on the trained machine learning model and the parameter associated with the contaminating process, determine a single-valued metric representing an impact of the contaminating process on the machine learning model's future prediction.

18. The system of claim 17, wherein the single-valued metric is determined as a function of a change due to contaminated input time series and a change due to parameter change induced by outliers in the time series data.

19. The system of claim 17, wherein a plurality of different outlier detecting machine learning models is used to estimate the contaminating process and the single-valued metric is determined for each of the plurality of different outlier detecting machine learning models, wherein the plurality of different outlier detecting machine learning models is ranked according to the associated single-valued metric.

20. The system of claim 17, wherein the processor is configured to create an adversarial contaminating process by generating the contamination process using a plurality of different machine learning structures, wherein a plurality of single-valued metrics are generated associated with the plurality of different machine learning structures respectively, wherein a machine learning structure is selected from the plurality of different machine learning structures based on the associated single-valued metric, and model parameters for the selected machine learning structure are computed using a constraint optimization.
